(19) United States
(12) Patent Application Publication
(10) Pub. No.: US 2023/0261404 A1
(43) Pub. Date: Aug. 17, 2023

(54) FLAT ARRAY GROUNDING WIRE AND GROUNDING METHOD

(71) Applicant: SUNGJIN INC, Cheongju-si, Chungcheongbuk-do (KR)

(72) Inventor: Jeong-Yeon SEO, Cheongju-si (KR)

(73) Assignee: SUNGJIN INC, Cheongju-si, Chungcheongbuk-do (KR)

(21) Appl. No.: 17/781,296

(22) PCT Filed: Feb. 15, 2022
(86) PCT No.: PCT/KR2022/002181

§ 371 Date: May 31, 2022

(51) Int. Cl. H01R 12/77; H01B 7/08; H01B 13/00

(52) U.S. Cl. CPC H01R 12/775; H01B 7/0823; H01B 13/0036

(57) ABSTRACT

In an electrical construction, grounding refers to a work for connecting a part of an electrical circuit or electrical equipment to the ground using a conductor.

Since the ground maintains approximately the same potential, circuit parts connected to the ground through a low-resistance conductor may be considered to have a uniform potential value, and a conductor connecting an electric device to the ground is called a grounding conductor or grounding wire.

The grounding wire is used with an insulating coating formed on the wire for the purpose of safety in processing. In the underground, the grounding wire is used in the form of a bare wire without the insulation coating for the purpose of close contact with the ground. The grounding wire can be used as a single wire when the size is small, however, if the size becomes large, several strands of wires are twisted and used in the form of a stranded wire.

A conventional grounding wire installed in the ground is composed of a single stranded wire, so an inner surface of the stranded wire does not come into contact with the ground, so it is difficult to lower the grounding resistance value.

Therefore, there are provided a flat array grounding wire and a grounding method using the same, in which the flat array grounding wire is configured to lower the grounding resistance value by greatly increasing the surface area in contact with the ground by arranging the grounding wires used for a grounding work in an electrical construction on a flat plane, so that the construction cost can be reduced as the grounding resistance value is lowered.

### TECHNICAL FIELD

The present invention relates to a grounding wire and a grounding method used for a grounding work in an electrical construction.

### BACKGROUND ART

In the electrical construction, grounding refers to a work for connecting a part of an electrical circuit or electrical equipment to the ground using a conductor.

Since the ground maintains approximately the same potential, circuit parts connected to the ground through a low-resistance conductor may be considered to have a uniform potential value, and a conductor connecting an electric device to the ground is called a grounding conductor or grounding wire.

The grounding wire is used with an insulating coating formed on the wire for the purpose of safety in processing. In the underground, the grounding wire is used in the form of a bare wire without the insulation coating for the purpose of close contact with the ground. The grounding wire can be used as a single wire when the size is small, however, if the size becomes large, several strands of wires are twisted and used in the form of a stranded wire.

When abnormal voltage or failure occurs in electrical equipment, it is necessary to immediately discharge the current to the ground, and this current is called earth fault current.

The earth fault current is sensitive to the magnitude of resistance between the electrical equipment and the ground. The grounding wire is a conductor having very small resistance so that the resistance can be ignored. The magnitude of resistance largely depends on resistance that exists between the conductor and the ground. In order to discharge the earth fault current to the ground, it is necessary to keep the resistance below the standard value, and such a resistance is called grounding resistance.

The magnitude of the grounding resistance is proportional to the size of a surface area of the conductor in contact with the ground, except for factors caused by general natural phenomena, and a grounding electrode is additionally installed to increase the surface area in contact with the ground.

A conventional grounding wire installed in the ground is composed of a single stranded wire, so an inner surface of the stranded wire does not come into contact with the ground, so it is difficult to lower the grounding resistance value.

### DISCLOSURE

### Technical Problem

The present invention provides a flat array grounding wire and a grounding method using the same, in which the flat array grounding wire is configured to lower the grounding resistance value by greatly increasing the surface area in contact with the ground by arranging the grounding wires used for a grounding work in an electrical construction on a flat plane, so that the construction cost can be reduced as the grounding resistance value is lowered.

### Technical Solution

In order to solve the above problem, a flat array grounding wire according to the present invention includes:
a wire bundle (11) including several stands of wires arranged on a plane at regular intervals and coupled to a plurality of spacers (12) at regular intervals; and
a plurality of spacers (12) coupled to the wire bundle (11) at regular intervals.

The flat array grounding wire may further include:
a connection part (14) having one side coupled to an insulation grounding wire (3) and the other side coupled to an annular spacer (13) and composed of several strands of wire; and
an annular spacer (13) coupled to the other side of the connection part (14) such that several strands of wire bundles (11) are kept annular at regular intervals.

A grounding method using a flat array grounding wire according to the present invention includes:
grounding material preparing step (S100) of preparing materials related to the grounding work to perform the grounding work;
grounding wire cutting step (S201) of cutting a wire bundle (11) by closely approaching to a spacer (12) corresponding to a desired length of a flat array grounding wire (10) to be used when the flat array grounding wire is used for an electric pole grounding;
grounding wire mesh forming step (S202) of forming the flat array grounding wire (10) in a form of a mesh on a flat ground when the flat array grounding wire is used for a mesh grounding;
connection part arranging step (S300) of modifying the spacer (12) close to a connection part (14) of the flat array grounding wire (10), which is cut or meshed in the above step, into an annular spacer (13) using a hand tool, and collecting and arranging the wire bundle (11) constituting the connection part (14) such that the wire bundle is easily connected;
grounding wire connecting step (S400) of peeling off a coating of an insulation grounding wire (3), which is inserted into an air core of an electric pole through a preliminary work, and connecting the connection part (14) when used for the electric pole grounding, or connecting the connection parts (14) that intersect each other when used for a mesh grounding by binding the connection part (14) or connection parts (14) using a separate wire or by pressing a connection sleeve;
electric pole erecting step (S501) of erecting the electric pole (2) in an electric pole pit (1) excavated through a preliminary work by lifting the electric pole (2) to which the flat array grounding wire (10) is connected with a crane when used for the electric pole grounding; and
grounding wire burying step (S600) of burying the flat array grounding wire (10) together with the electric pole (2) by back-filling with a soil using a long rod such that the flat array grounding wire (10) is separated from the electric pole (2) when used for the electric pole grounding, or sufficiently back-filling with the soil on the flat array grounding wire (10) formed with a mesh net to reach a standard height or above when used for the mesh grounding.

### Advantageous Effects

As described above, according to the flat array grounding wire and the grounding method of the present invention, an existing single-strand grounding wire is modified to have several strands with the same sectional area, so that the surface area in contact with the ground can be enlarged, thereby significantly lowering the grounding resistance value, and the number of grounding equipment can be reduced proportional to the decrease of the grounding resistance value, so that the construction cost related to the grounding can be advantageously reduced.

### DESCRIPTION OF DRAWINGS

FIG. 1 is a view showing the configuration of a flat array grounding wire according to one example of the present invention.

FIG. 2 is a view showing the configuration of a flat array grounding wire according to another example of the present invention.

FIG. 3 is a view showing cutting of a flat array grounding wire according to one example of the present invention.

FIG. 4 is a view showing the use of mesh grounding of a flat array grounding wire according to one example of the present invention.

FIG. 5 is a view showing a mesh grounding connection part of a flat array grounding wire according to one example of the present invention.

FIG. 6 is a view showing the use of a flat array grounding wire for an electric pole grounding according to another example of the present invention.

FIG. 7 is a view showing a grounding method of a flat array grounding wire according to an example of the present invention.

* Description of Reference numerals in Drawings *

| | |
|---|---|
| 1: electric pole pit | 2: electric pole |
| 3: shielded grounding wire | |
| 10: flat array grounding wire | |
| 11: wire bundle | 12: spacer |
| 13: annular spacer | 14: connection part |

### BEST MODE

### Mode for Invention

Hereinafter, specific contents for carrying out the present invention will be described in detail with reference to the accompanying drawings.

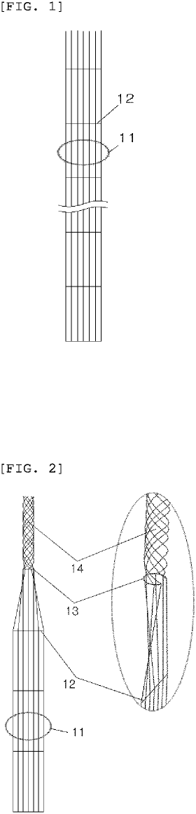

First, a configuration of a flat array grounding wire according to the present invention will be described with reference to FIGS. 1 and 2.

A flat array grounding wire consists of a wire bundle 11 including several stands of wires arranged on a plane at regular intervals and coupled to a plurality of spacers 12 at regular intervals; and

a plurality of spacers (12) coupled to the wire bundle 11 at regular intervals.

The wire bundle 11 is configured by dividing the existing single-core grounding wire into several strands with the same sectional area, so that the surface area in contact with the ground can be enlarged, thereby greatly reducing the grounding resistance value.

In addition, the spacer 12 maintains an appropriate distance such that the grounding resistance value can be prevented from being increased, which may occur if several strands of bare wires are biased to one spot in the process of burying he wire bundle 11, or the several strands of bare wires can be prevented from being scattered in various directions so that installation is not inconvenient. The spacer 12 functions to suppress the generation of unbalanced earth fault current between the wires.

The flat array grounding wire may further include a connection part 14 having one side coupled to an insulation grounding wire 3 and the other side coupled to an annular spacer 13 and composed of several strands of wire; and

an annular spacer 13 coupled to the other side of the connection part 14 such that several strands of wire bundles 11 are kept annular at regular intervals.

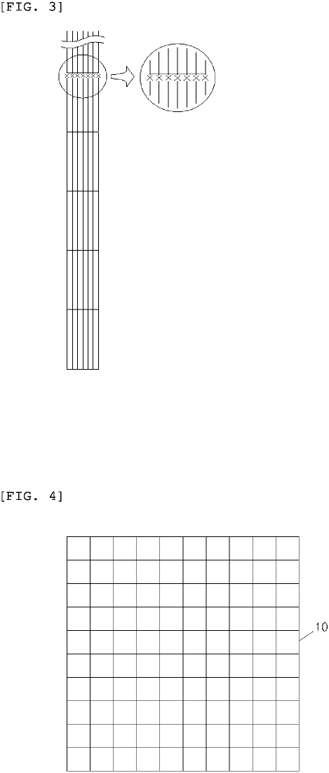

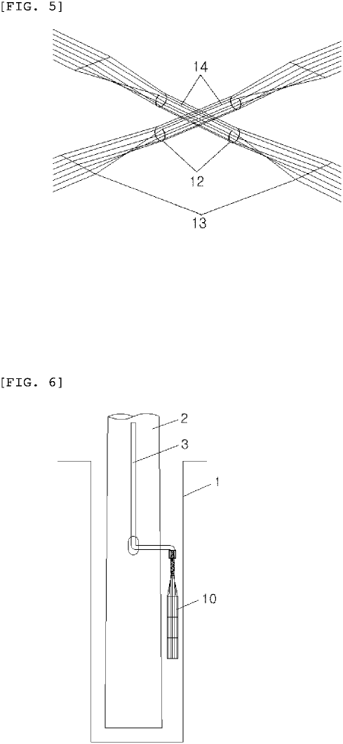

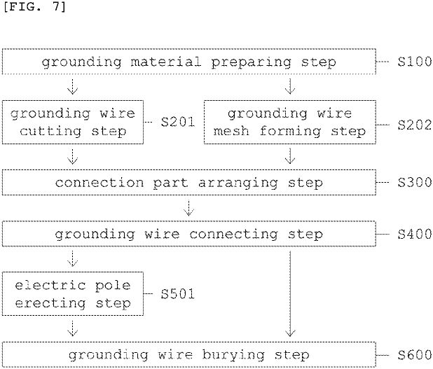

Next, a grounding method using a flat array grounding wire according to the present invention will be described with reference to FIGS. 1 to 7.

Prior to the explanation, as shown in FIGS. 4 and 6, if the place of use for the flat array grounding wire is an electric pole construction site of a distribution line it is called an electric pole grounding, and if it is a grounding construction site to form a large-scale network to obtain a low grounding resistance value, it is called a mesh grounding.

The grounding method includes:
grounding material preparing step (S100) of preparing materials related to the grounding work to perform the grounding work;
grounding wire cutting step (S201) of cutting a wire bundle 11 by closely approaching to a spacer 12 corresponding to a desired length of a flat array grounding wire 10 to be used when the flat array grounding wire is used for an electric pole grounding;
grounding wire mesh forming step (S202) of forming the flat array grounding wire 10 in the form of a mesh on a flat ground when the flat array grounding wire is used for a mesh grounding;
connection part arranging step (S300) of modifying the spacer 12 close to a connection part 14 of the flat array grounding wire 10, which is cut or meshed in the above step, into an annular spacer 13 using a hand tool, and collecting and arranging the wire bundle 11 constituting the connection part 14 such that the wire bundle is easily connected;
wherein, when the wire bundle 11 coupled in parallel with the straight spacer 12 is gathered into one, there is a difference in length between the center and the outer wire so that an unbalanced earth fault current occurs, so the spacer 12 close to the connection part 14 is modified into an annular space 13, so that the length difference between the strands is eliminated,
grounding wire connecting step (S400) of peeling off a coating of an insulation grounding wire 3, which is inserted into an air core of an electric pole through a preliminary work, and connecting the connection part 14 when used for the electric pole grounding, or connecting the connection parts 14 that intersect each other when used for a mesh grounding by binding the connection part 14 or connection parts 14 using a separate wire or by pressing a connection sleeve;
electric pole erecting step (S501) of erecting the electric pole 2 in an electric pole pit 1 excavated through a preliminary work by lifting the electric pole 2 to which the flat array grounding wire 10 is connected with a crane when used for the electric pole grounding; and
grounding wire burying step (S600) of burying the flat array grounding wire 10 together with the electric pole 2 by back-filling with a soil using a long rod such that the flat array grounding wire 10 is separated from the electric pole 2 when used for the electric pole grounding, or sufficiently back-filling with the soil on the flat array grounding wire 10 formed with a mesh net to reach a standard height or above when used for the mesh grounding.

As described above, according to the flat grounding wire and the grounding method of the present invention, the existing single-core grounding wire is divided into several strands with the same sectional area in the grounding equipment construction, so that the surface area in contact with the ground can be enlarged, and the grounding resistance value can be greatly reduced. As a result, the number of grounding equipment can be reduced proportional to the decrease of the grounding resistance value, thereby providing an advantageous effect for reducing the construction cost related to the grounding work.

In the above-described contents, the contents not shown in the drawings are contents that can be fully understood by those skilled in the art based on the above-described contents, and should be included in the right of the present invention even if they are not shown in the drawings.

### INDUSTRIAL APPLICABILITY

The present invention provides a grounding electrode and a grounding method used to construct grounding equipment in an electrical construction, and is greatly advantageous in obtaining a low grounding resistance value compared to a grounding wire composed of a conventional single core, thereby reducing the construction cost for the grounding equipment and being expected to be widely used in the field of electric constructions.

1. A flat array grounding wire used for a grounding work in an electrical construction, the flat array grounding wire comprising:
a wire bundle (11) including several stands of wires arranged on a plane at regular intervals and coupled to a plurality of spacers (12) at regular intervals; and
a plurality of spacers (12) coupled to the wire bundle (11) at regular intervals.

2. A grounding method used for a grounding work in an electrical construction, the grounding method comprising:
grounding material preparing step (S100) of preparing materials related to the grounding work to perform the grounding work;
grounding wire cutting step (S201) of cutting a wire bundle (11) by closely approaching to a spacer (12) corresponding to a desired length of a flat array grounding wire (10) to be used when the flat array grounding wire is used for an electric pole grounding;
grounding wire mesh forming step (S202) of forming the flat array grounding wire (10) in a form of a mesh on a flat ground when the flat array grounding wire is used for a mesh grounding;
connection part arranging step (S300) of modifying the spacer (12) close to a connection part (14) of the flat array grounding wire (10), which is cut or meshed in the above step, into an annular spacer (13) using a hand tool, and collecting and arranging the wire bundle (11) constituting the connection part (14) such that the wire bundle is easily connected;
grounding wire connecting step (S400) of peeling off a coating of an insulation grounding wire (3), which is inserted into an air core of an electric pole through a preliminary work, and connecting the connection part (14) when used for the electric pole grounding, or connecting the connection parts (14) that intersect each other when used for a mesh grounding by binding the connection part (14) or connection parts (14) using a separate wire or by pressing a connection sleeve;
electric pole erecting step (S501) of erecting the electric pole (2) in an electric pole pit (1) excavated through a preliminary work by lifting the electric pole (2) to which the flat array grounding wire (10) is connected with a crane when used for the electric pole grounding; and
grounding wire burying step (S600) of burying the flat array grounding wire (10) together with the electric pole (2) by back-filling with a soil using a long rod such that the flat array grounding wire (10) is separated from the electric pole (2) when used for the electric pole grounding, or sufficiently back-filling with the soil on the flat array grounding wire (10) formed with a mesh net to reach a standard height or above when used for the mesh grounding.
